(19) United States
(12) Patent Application Publication
(10) Pub. No.: US 2006/0140670 A1
(43) Pub. Date: Jun. 29, 2006

(54) Image forming apparatus

(75) Inventors: Dong-ha Choi, Suwon-si (KR); Byung-sun Ahn, Suwon-si (KR); Sea-chul Bae, Suwon-si (KR); Sung-won Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/318,592

(22) Filed: Dec. 28, 2005

(30) Foreign Application Priority Data
Dec. 29, 2004 (KR) 10-2004-0115040

(51) Int. Cl. G03G 15/00

(52) U.S. Cl. 399/110

(57) ABSTRACT

An image forming apparatus includes a scanning unit for reading images of a document, and a printing unit that includes an exposing unit to form an electrostatic latent image corresponding to the image read by the scanning unit. The exposing unit is mounted on the scanning unit to be moved with the scanning unit when the scanning unit rotates with respect to the printing unit.

### CROSS-REFERENCE TO RELATED PATENT APPLICATIONS

This application claims the benefit under 35 U.S.C. § 119(a) of Korean Patent Application No. 10-2004-0115040, filed on Dec. 29, 2004, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an image forming apparatus that can be made smaller by mounting an exposing unit on a scanning unit.

2. Description of the Related Art

In general, a multi-functional peripheral device is a device capable of performing multiple functions by combining a scanning function to read a document and input an image, a printing function to print an image, and any other desired functions into one device.

FIG. 1 is a sectional side view of a conventional image forming apparatus. Referring to FIG. 1, the image forming apparatus 1 includes a printing unit 10, a scanning unit 80, and a receiving unit 70 installed between the printing unit 10 and the scanning unit 80. The receiving unit 70 receives printing media (S) on which a toner image is fused as the printing media is discharged from the apparatus.

The printing unit 10 prints desired images, and includes a cassette 20, a developing device 30, a transfer roller 32, a fusing device 50, and a discharging device 60.

The cassette 20 loads the printing media (S) under a main body 1 of the apparatus, and is detachably installed. A pickup roller 21 is installed on an upper portion of the cassette 20 to pick up the printing media (S) sheet by sheet.

In the developing device 30, a photosensitive drum 31 has a surface charged to a predetermined potential. An electrostatic latent image is formed on the surface by light irradiated by an exposing unit 40 such as a laser scanning unit (LSU). The printing media (S) passes between the transfer roller 32 and the photosensitive drum 31. In addition, toner is stored in the developing device 30, and the toner is supplied to the photosensitive drum 31 to develop the electrostatic latent image into a toner image.

The transfer roller 32 contacts the photosensitive drum 31, and presses the printing media (S), which passes between the transfer roller 32 and the photosensitive drum 31, toward the photosensitive drum 31 so that the toner image formed on the photosensitive drum 31 can be transferred onto the printing media (S).

The fusing device 50 is installed on a conveying path of the printing media (S), and heats and presses the toner image transferred onto the printing media (S) to fuse the toner image onto the printing media (S).

The discharging device 60 discharges the printing media (S), on which the toner image is fused by the fusing device 50, onto the receiving unit 70.

The scanning unit 80 is disposed above the main body 1 for inputting images of a document by irradiating light onto the document, and includes a scanning frame 81 fixed on the upper portion of the main body and a cover 84 rotatably installed on the scanning frame 81.

A glass plate 83 is installed at the upper portion of the scanning frame 81, and an image sensor 82 that reads a document placed on the glass plate 83 and inputs the image of a document is disposed under the glass plate 83.

The printing medium (S) is picked up from the cassette 20 and passes through the developing device 30 and the fusing device 50 to form the image thereon, and is then discharged by the discharging device 60 and stacked in the receiving unit 70.

Since the image forming apparatus includes both a printing unit and a scanning unit, the size of the apparatus is larger. In the past, conventional image forming apparatuses were mainly used in office environments and the size of the apparatus was not a significant concern. Recently, however, image forming apparatuses have been used for personal use, and thus, the size of the apparatus needs to be minimized. When the image forming apparatus is used for the personal use, the space required to install the unit should be reduced, and the space usage of the apparatus should be within the installation space.

To minimize the size of the image forming apparatus, the space occupied by the printing unit, the scanning unit, and the receiving unit should be minimized.

Accordingly, there is a need for an improved multi-function image forming apparatus which is more compact and utilizes space more efficiently.

### SUMMARY OF THE INVENTION

An aspect of the present invention is to address at least the above problems and/or disadvantages and to provide at least the advantages described below. Accordingly, an aspect of the present invention is to provide an image forming apparatus, the size of which is minimized by installing an exposing unit on a lower portion of a scanning unit and discharging printing media to a side surface of the apparatus.

According to an aspect of the present invention, an image forming apparatus including a scanning unit that reads images of a document, and a printing unit that includes an exposing unit that forms an electrostatic latent image corresponding to the image read by the scanning unit to form an image of the document image. The exposing unit is mounted on the scanning unit to be moved with the scanning unit when the scanning unit rotates with respect to the printing unit.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic, sectional side view of a conventional image forming apparatus;

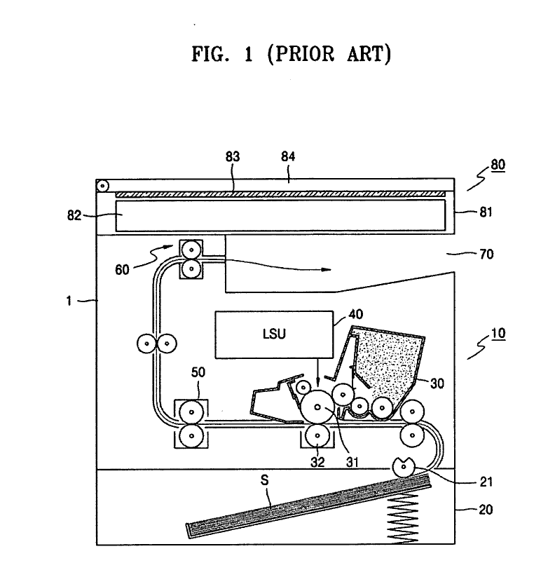

FIG. 2 is a sectional side view of an image forming apparatus including an exposing unit according to an exemplary embodiment of the present invention;

FIG. 3 is a partial enlarged view of the exposing unit of FIG. 2 installed on the apparatus according to an exemplary embodiment of the present invention;

FIG. 4 is a sectional side view of a scanning unit opened with respect to a printing unit in the image forming apparatus including the exposing unit of FIG. 2;

FIG. 5 is a sectional side view of an image forming apparatus including an exposing unit according to another exemplary embodiment of the present invention; and

FIG. 6 is a sectional side view of a scanning unit opened with respect to a printing unit in the image forming apparatus including the exposing unit of FIG. 5.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

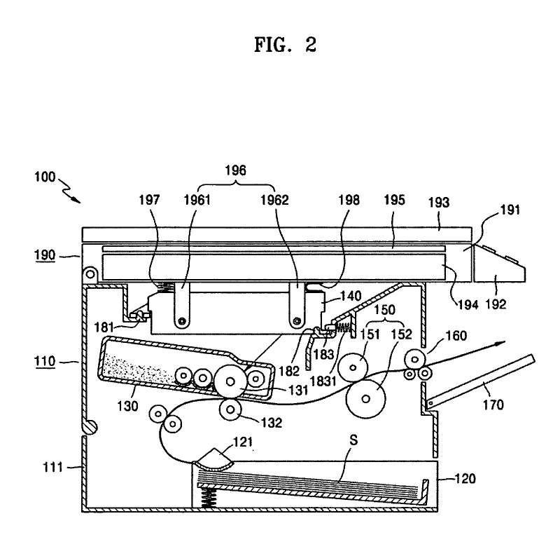

Referring to FIG. 2, an image forming apparatus 100 includes a printing unit 110 and a scanning unit 190.

The printing unit 110 forms desired images and includes a cassette 120, a developing device 130, a transfer roller 132, a fusing device 150, a discharging device 160, and a receiving unit 170.

The cassette 120 holds a plurality of printing media (S) under a main body 111, and is detachably installed on the main body 111. A pickup roller 112 is installed above the cassette 120 to pick up the printing media (S) sheet by sheet. The pickup roller 112 rotates to pick up a sheet of the printing media (S) and supplies the printing medium (S) to the developing device 130.

The developing device 130 includes a photosensitive drum 131 having a surface discharged to a predetermined potential. An electrostatic latent image is formed on the surface of the photosensitive drum 131 by light irradiated by an exposing unit 140 such as a laser scanning unit (LSU). The photosensitive drum 131 presses against the transfer roller 132, while the printing media (S) passes between them. In addition, toner is stored in the developing device 130, and the toner is supplied to the photosensitive drum 131 to develop the electrostatic latent image into a toner image.

The transfer roller 132 presses the printing media (S) passing between the transfer roller 132 and the photosensitive drum 131 toward the photosensitive drum 131 so that the toner image formed on the photosensitive drum 131 can be transferred onto the printing media (S).

The fusing device 150 is installed on a conveying path of the printing media (S), and heats and presses the toner image transferred onto the printing media (S) to fuse the toner image onto the printing media (S). The fusing device 150 includes a heating roller 151 generating heat, and a pressing roller 152 contacting the heating roller 151 to press the printing media (S) passing therebetween toward the heating roller 151.

The discharging device 160 discharges the printing media (S), on which the toner image is fused by the fusing device 150, onto the receiving unit 170. The receiving unit 170 rotates at the side surface of the main body 111, and can be attached to and detached from the main body 111.

The scanning unit 190 is disposed on the upper portion of the printing unit 110, and inputs an image by irradiating light onto a document. The scanning unit 190 includes a scanning frame 191 rotatably installed on the main body 111 of the printing unit 110 by a hinge, a cover 193 rotated with respect to the scanning frame 191, and a control unit 192 for controlling the scanning unit 190.

A glass plate 195 is installed on the scanning frame 191, and an image sensor 194 reading the image of document placed on the glass plate 195 and inputting the image is installed under the glass plate 195. The image sensor 194 can be slid with respect to the scanning frame 191, and irradiates the light onto the document and reads out the image while sliding under the document.

The exposing unit 140 is fixed on the scanning frame 191 of the scanning unit 190 by a mounting unit 196. The mounting unit 196 is supported by a plurality of mounting support units 1961 and 1962 that protrude from the lower portion of the scanning unit 190. A plurality of elastic units 197 and 198 support the exposing unit 140 between the exposing unit 140 and the scanning frame 191. Two mounting support units 1961 and 1962 are vsible in FIG. 2. Preferably, however, the same number of mounting support units are disposed at the opposite side of the image forming apparatus to support the exposing unit 140 (that is, there are preferably four mounting support units).

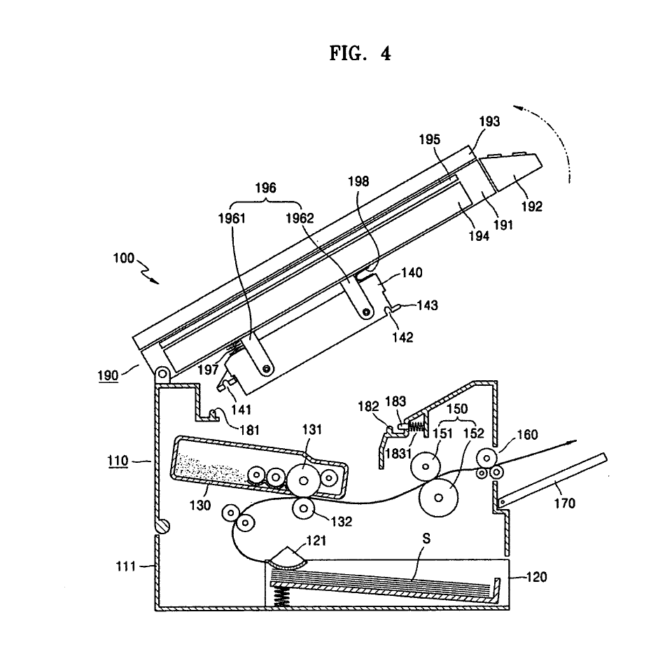

Referring to FIG. 4, the exposing unit 140 includes a plurality of mounting holes 141 and 142, and the main body 111 includes corresponding position guide units 181 and 182 that are inserted into the mounting holes 141 and 142.

The position guide units 181 and 182 are formed to maintain the exposing unit 140 at a constant position even when the exposing unit 140 is attached to or detached from the printing unit 110 with the scanning unit 190. Thus, the light irradiated by the exposing unit 140, reaches the photosensitive drum 131 through the same light path.

The elastic units 197 and 198 provide the exposing unit 140 with elastic force so that the exposing unit 140 mounted on the mounting unit 196 does not move and the light path of the light irradiated from the exposing unit 140 is constant.

In addition, a protrusion 143 is formed on a side of the exposing unit 140, and a locking unit 183 that is elastically biased toward the exposing unit 140 by a spring 1831 is disposed on the main body 111 corresponding to the protrusion 143.

Preferably, the protrusion 143 and the locking unit 183 are rounded so that these are coupled to and separated from each other when the scanning unit 190 is mounted to or detached from the printing unit 110.

The operations of mounting the exposing unit to or detaching the exposing unit from the printing unit in the image forming apparatus including the exposing unit of the exemplary embodiment of the present invention will now be described.

Referring to FIGS. 2 and 4, when the scanning unit 190 is coupled to the printing unit 110, the position guide units 181 and 182 are inserted into the mounting holes 141 and 142, and the protrusion 143 is coupled to the locking unit 183 and fixed.

The light from the exposing unit 140 is radiated to the photosensitive drum 131 of the developing device 130 to form the electrostatic latent image corresponding to the image data on the surface of the photosensitive drum 131.

When the scanning unit 190 rotates with respect to the printing unit 110 and is separated from the printing unit 110, the position guide units 181 and 182 are separated from the mounting holes 141 and 142 respectively, and the protrusion 143 is also separated from the locking unit 183.

Here, the upper portion of the printing unit 110 is exposed to the outside when the exposing unit 140 is separated from the printing unit 110. The developing device 130 can be separated from or installed into the printing unit 110 through the exposed portion of the printing unit 110. In addition, if a paper jam occurs between the developing device 130 and the transfer roller 132, it can be removed through the exposed portion of the printing unit 110.

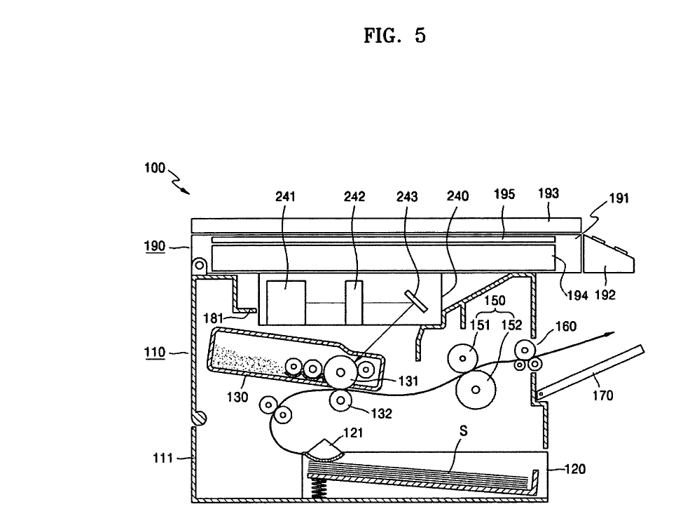

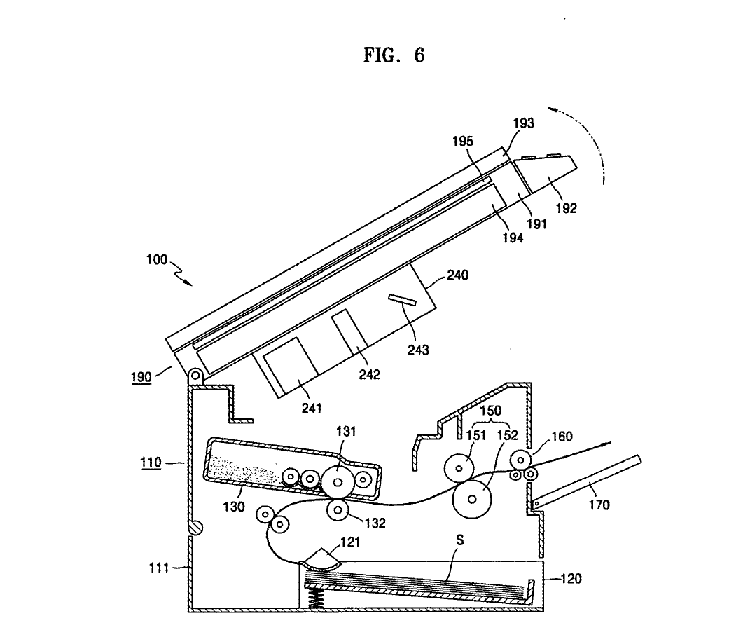

FIG. 5 is a sectional side view of an image forming apparatus including an exposing unit according to another exemplary embodiment of the present invention, and FIG. 6 is a sectional side view of the scanning unit opened with respect to the printing unit in the image forming apparatus including the exposing unit of FIG. 5.

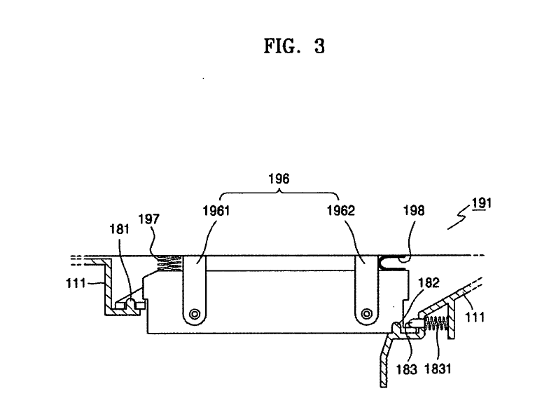

Referring to FIGS. 5 and 6, the image forming apparatus has the same structure as that of the image forming apparatus shown in FIGS. 2 through 4 except for the exposing unit 240, which is integrally formed on the scanning unit 190.

The exposing unit 240 is integrally formed with the scanning frame 191 at the lower portion of the scanning unit 190. That is, when the scanning unit 190 is fabricated, the exposing unit 240 is fabricated together with the scanning unit 190. In the exposing unit 240, a motor 241, a lens 242, and a reflective mirror 243 are disposed on the light path.

The exposing unit 240 may additionally include the position guide units 181 and 182, and the locking unit 183 shown in FIG. 2.

The operation and effect of the image forming apparatus including the exposing unit 240 according to the exemplary embodiment illustrated in FIGS. 5 and 6 is the same as that of the image forming apparatus shown in FIGS. 2 through 4. Therefore, a detailed description is not repeated for conciseness.

As described above, in the image forming apparatus according to the present invention, the exposing unit is opened and closed together with the scanning unit, and thus, a paper jam can be easily removed. In addition, since some units of the apparatus can be minimized and integrated with each other, the image forming apparatus can be minimized, and can have a lighter weight.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image forming apparatus comprising:
a scanning unit for reading images of a document; and
a printing unit including an exposing unit that forms an electrostatic latent image on a photosensitive drum in the printing unit,
wherein the exposing unit is mounted on the scanning unit to be moved with the scanning unit when the scanning unit rotates with respect to the printing unit.

2. The apparatus of claim 1, wherein
the exposing unit forms an electrostatic latent image that corresponds to the image read by the scanning unit to thereby form an image of the document image.

3. The apparatus of claim 1, wherein
the scanning unit includes a mounting unit, to which the exposing unit can be mounted.

4. The apparatus of claim 3, wherein
the mounting unit is disposed on a lower portion of the scanning unit.

5. The apparatus of claim 1, wherein
the printing unit includes a plurality of position guide units, and
the exposing unit includes a plurality of mounting holes that are coupled to the position guide units of the printing unit.

6. The apparatus of claim 1, wherein
the printing unit includes a locking unit that fixes the exposing unit to the printing unit.

7. The apparatus of claim 1, wherein
the exposing unit is integrally formed on the scanning unit.

8. The apparatus of claim 1, wherein
an upper portion of the printing unit is opened and closed according to the rotation of the scanning unit with respect to the printing unit.

9. An image forming apparatus comprising:
a main body;
a scanning unit rotatably disposed on the main body so that it can be opened and closed with respect to the main body;
a printing unit for forming images on a printing media, the printing unit having a photosensitive drum; and
an exposing unit for generating electrostatic latent images on a surface of the photosensitive drum, the exposing unit being mounted on the scanning unit to move with the scanning unit when the scanning unit is rotated with respect to the main body.

10. The apparatus of claim 9, further comprising
a mounting unit disposed on the scanning unit to mount the exposing unit to the scanning unit.

11. The apparatus of claim 10, wherein the mounting unit comprises:
a plurality of mounting support units that protrude from a lower portion of the scanning unit.

12. The apparatus of claim 11, further comprising
a plurality of elastic units disposed between the exposing unit and the scanning unit.

13. The apparatus of claim 12, wherein
the printing unit includes a plurality of position guide units, and
the exposing unit includes a plurality of mounting holes that are coupled to the position guide units of the printing unit.

14. The apparatus of claim 13, wherein
the printing unit includes a locking unit that fixes the exposing unit to the printing unit.

15. The apparatus of claim 9, wherein
the exposing unit is integrally formed on the scanning unit.
